(19) United States
(12) Patent Application Publication
(10) Pub. No.: US 2026/0295514 A1
(43) Pub. Date: Oct. 1, 2026

(54) PURGE DEVICE AND PRODUCTION METHOD FOR SEPARATION MEMBRANE

(71) Applicant: MITSUBISHI HEAVY INDUSTRIES, LTD., Tokyo (JP)

(72) Inventors: Yoshiaki Ito, Tokyo (JP); Ryo Kamito, Tokyo (JP); Taichi Yoshii, Tokyo (JP); Norihisa Horaguchi, Tokyo (JP); Tatsuo Ishiguro, Tokyo (JP); Yoshie Togano, Tokyo (JP); Naoya Miyoshi, Tokyo (JP)

(73) Assignee: MITSUBISHI HEAVY INDUSTRIES, LTD., Tokyo (JP)

(21) Appl. No.: 18/996,423

(22) PCT Filed: Feb. 16, 2023
(86) PCT No.: PCT/JP2023/005557

§ 371 Date: Jan. 17, 2025

(30) Foreign Application Priority Data
Jul. 27, 2022 (JP) 2022-119524

(51) Int. Cl. B01D 53/22; B01D 67/00; B01D 69/02; B01D 71/02; C09K 5/04

(52) U.S. Cl. CPC B01D 53/228; B01D 67/0067; B01D 69/02; B01D 71/021; C09K 5/044; B01D 2256/26; B01D 2257/102; B01D 2257/104; B01D 2325/02831; C09K 2205/122

(57) ABSTRACT

A purge device includes a purge pipe that is connected to a condenser and purges a mixed gas containing a refrigerant gas and a non-condensable gas from the condenser; a separation device having a separation membrane that is provided in the purge pipe and separates the non-condensable gas from the mixed gas purged by the purge pipe with a pressure difference; and an exhaust pipe that guides a gas containing the non-condensable gas separated by the separation membrane to an outside. The separation membrane is a carbon membrane.

### TECHNICAL FIELD

The present disclosure relates to a purge device and a production method for a separation membrane.

Priority is claimed on Japanese Patent Application No. 2022-119524, filed Jul. 27, 2022, the content of which is incorporated herein by reference.

### BACKGROUND ART

In a refrigerator using a refrigerant having an operating pressure that becomes a negative pressure in a part of the refrigerator during operation (so-called low-pressure refrigerant), a non-condensable gas such as air enters the refrigerator from a negative pressure part, passes through a compressor or the like, and then stays in a condenser. In a case where the non-condensable gas stays in the condenser, the refrigerant condensation performance in the condenser is hindered, and the performance as a refrigerator deteriorates. Therefore, constant performance is ensured by purging the refrigerant containing the non-condensable gas from the refrigerator using a purge device, and discharging the non-condensable gas to the outside of the refrigerator.

For example, a purge device described in Patent Document 1 is configured to have a separation membrane (gas separation membrane) attached to the upper part in a purge tank to separate the purge tank into a refrigerator and an outside air side across the separation membrane as a boundary and to lower the pressure in the outside air side with a vacuum pump to discharge a non-condensable gas to the atmosphere.

### CITATION LIST

### Patent Document

Patent Document 1: Japanese Unexamined Patent Application, First Publication No. 2008-96027

### SUMMARY OF INVENTION

### Technical Problem

In a purge device including a separation membrane, in a case where a polymer membrane (for example, a polyimide membrane) is adopted as the separation membrane, a phenomenon of plasticization in which the membrane structure of the polymer membrane physically alters due to contact with a liquid refrigerant occurs. In a case where plasticization occurs in the separation membrane, the permeation rate of the refrigerant in the separation membrane increases, and the separation of a non-condensable gas becomes insufficient. That is, there is a problem in that the non-condensable gas separation performance in the separation membrane deteriorates.

Furthermore, a gaseous refrigerant that is purged from the condenser to the purge device together with the non-condensable gas is in a saturated state, the refrigerant is thus likely to be easily condensed and liquefied by slight cooling. In a case where the purged refrigerant is heated with a heater when the purge device is in operation, the liquefaction of the refrigerant can be suppressed; however, when the operation is stopped, the refrigerant is not heated with the heater, the refrigerant existing in a gas state in the vicinity of the separation membrane is thus liquefied, and an event in which a liquid refrigerant comes into contact with the separation membrane occurs. Therefore, in a case where the polymer membrane is used as the separation membrane, it is difficult to avoid plasticization of the separation membrane only by installing the heater.

The present disclosure has been made in order to solve the above-described problem, and an object of the present disclosure is to provide a purge device, in which deterioration of the non-condensable gas separation performance can be suppressed even in a case where a liquid refrigerant comes into contact with a separation membrane, and a production method for a separation membrane.

### Solution to Problem

In order to solve the above-described problem, a purge device according to the present disclosure includes a purge pipe that is connected to a condenser and purges a mixed gas containing a refrigerant gas and a non-condensable gas from the condenser, a separation membrane that is provided in the purge pipe and separates the non-condensable gas from the mixed gas purged by the purge pipe with a pressure difference, and an exhaust pipe that guides a gas containing the non-condensable gas separated by the separation membrane to an outside, and the separation membrane is a carbon membrane.

The production method for a separation membrane according to the present disclosure is a production method for a separation membrane for producing a separation membrane that separates a non-condensable gas from a mixed gas containing a refrigerant gas and the non-condensable gas, the method having a step of obtaining a membrane-forming body by forming a membrane of a membrane-forming stock solution containing a polymer material, a step of obtaining a precursor polymer membrane by drying the membrane-forming body, and a step of obtaining the separation membrane as a carbon membrane having a pore diameter of 0.3 nm or more and 0.5 nm or less by subjecting the precursor polymer membrane to a carbonization treatment at 450° C. to 850° C.

### Advantageous Effects of Invention

According to the present disclosure, it is possible to suppress deterioration of a non-condensable gas separation performance even in a case where a liquid refrigerant comes into contact with a separation membrane.

### BRIEF DESCRIPTION OF DRAWINGS

FIG. 1 A configuration diagram of a purge device according to an embodiment of the present disclosure.

FIG. 2 A configuration diagram of a separation module in the purge device of FIG. 1.

FIG. 3 A configuration diagram of a separation membrane in the purge device of FIG. 1, and is a diagram showing a case where air permeates the cylindrical separation membrane from the inside to the outside.

FIG. 4 A configuration diagram of the separation membrane in the purge device of FIG. 1, and is a diagram showing a case where air permeates the cylindrical separation membrane from the outside to the inside.

FIG. 5 A flowchart showing a production method for a separation membrane according to one embodiment of the present disclosure.

FIG. 6 A graph comparing a carbon membrane and a polymer membrane in terms of a permeation rate of a refrigerant in the separation membrane.

FIG. 7 A graph comparing the carbon membrane and the polymer membrane in terms of separation performance in the separation membrane after being immersed in a liquid refrigerant.

### DESCRIPTION OF EMBODIMENT

### Embodiment

A purge device according to a first embodiment of the present disclosure will be described with reference to the drawings.

### [Configuration of Refrigerator]

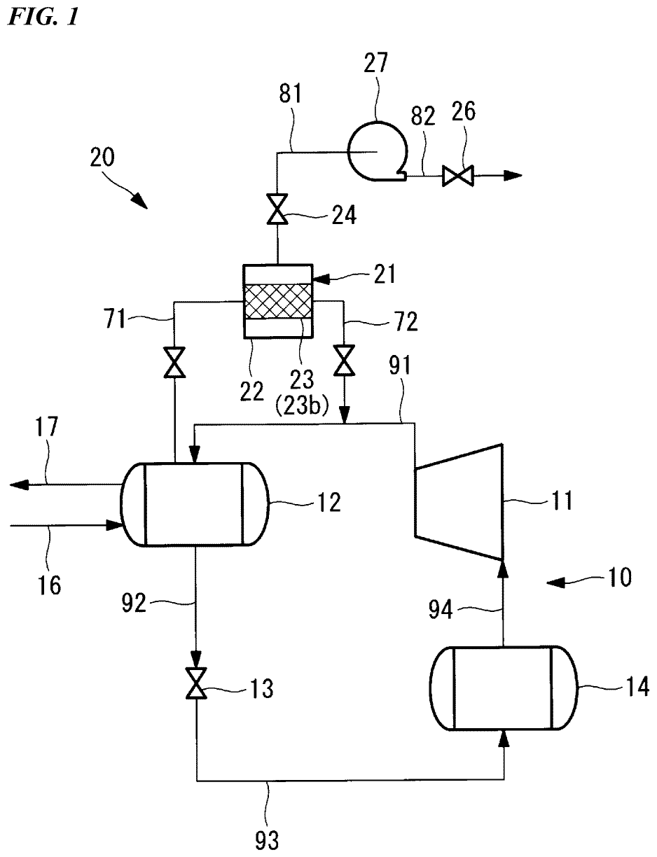

First, the configuration of a refrigerator 10 will be described. As shown in FIG. 1, the refrigerator 10 has a compressor 11, a condenser 12, an expansion valve 13, an evaporator 14, and refrigerant pipes 91, 92, 93, and 94 that connect these devices.

The compressor 11 is a device that compresses a refrigerant. The compressor 11 is driven by a motor (not shown). The compressor 11 may be, for example, a centrifugal compressor.

The condenser 12 is a device that condenses a high-temperature and high-pressure gas refrigerant compressed by the compressor 11. The condenser 12 may be, for example, a shell-and-tube type heat exchanger.

The condenser 12 has a large number of heat transfer tubes for a cooling medium (not shown) inserted thereinto. A cooling medium for cooling the refrigerant (for example, cooling water) flows into the heat transfer tubes for a cooling medium. A cooling water supply pipe 16 for supplying cooling water to the heat transfer tubes for a cooling medium and a cooling water return pipe 17 for discharging heat-exchanged cooling water from the heat transfer tubes for a cooling medium are connected to the heat transfer tubes for a cooling medium.

The expansion valve 13 is a device that expands a liquid refrigerant discharged from the condenser 12. The expansion valve 13 is configured to be capable of adjusting the opening degree thereof. The opening degree of the expansion valve 13 is appropriately set according to the specifications.

A sub-cooler (not shown) may be provided, for example, between the condenser 12 and the expansion valve 13. The sub-cooler is a device that supercools the refrigerant condensed by the condenser 12.

The evaporator 14 is a device that evaporates the liquid refrigerant expanded by the expansion valve 13. The evaporator 14 may be, for example, a shell-and-tube type heat exchanger.

The refrigerant pipe 91 is a pipe that connects a refrigerant outlet of the compressor 11 and a refrigerant inlet of the condenser 12. The refrigerant pipe 92 is a pipe that connects a refrigerant outlet of the condenser 12 and the expansion valve 13. The refrigerant pipe 93 is a pipe that connects the expansion valve 13 and a refrigerant inlet of the evaporator 14. The refrigerant pipe 94 is a pipe that connects a refrigerant outlet of the evaporator 14 and a refrigerant inlet of the compressor 11.

### [Configuration of Purge Device]

Next, the configuration of a purge device 20 will be described. The purge device 20 is a device that discharges a non-condensable gas that has entered a refrigerant system of the refrigerator 10 and stayed in the condenser 12 to the outside. The non-condensable gas is, for example, air mainly containing a nitrogen gas and an oxygen gas. In the present embodiment, air will be described as an example.

A low-pressure refrigerant (for example, R1233zd (E)) is used as the refrigerant. Therefore, during the operation of the refrigerator 10, a low-pressure part, such as the evaporator 14, becomes equal to or lower than the atmospheric pressure.

The purge device 20 is provided between the condenser 12 and the compressor 11. The purge device 20 has purge pipes 71 and 72, a separation device 21, exhaust pipes 81 and 82, and a vacuum pump 27.

The purge pipe 71 is connected to the condenser 12 at one end and is connected to the separation device 21 at the other end. In addition, the purge pipe 72 is connected to the separation device 21 at one end and is connected to the refrigerant pipe 91 or the compressor 11 at the other end. As a result, a purge system is configured.

The purge system is configured to guide a gas purged from the condenser 12 (a mixed gas containing a refrigerant gas and air; hereinafter, simply referred to as “mixed gas”) to the separation device 21 through the purge pipe 71, perform a treatment, which will be described below, in the separation device 21, and then return the mixed gas to the refrigerant pipe 91 or the compressor 11 existing upstream of the condenser 12 through the purge pipe 72.

During the operation of the refrigerator 10, in general, the pressure is higher in the refrigerant pipe 91 or the compressor 11 than in the condenser 12, and it can be thus considered that the purged mixed gas does not flow from the condenser 12 toward the refrigerant pipe 91 or the compressor 11.

However, in the present embodiment, the purge system is configured such that the purge pipe 72 is connected to a predetermined place of the refrigerant pipe 91 or the compressor 11, whereby the mixed gas flows from the condenser 12 toward the refrigerant pipe 91 or the compressor 11.

As a result, the mixed gas (mainly the refrigerant gas) from which the air has been separated in the separation device 21 can be returned to the upstream side of the condenser 12.

The exhaust pipe 81 is connected to the separation device 21 at one end and is connected to the vacuum pump 27 at the other end. In addition, the exhaust pipe 82 is connected to the vacuum pump 27 at one end and is opened to the atmospheric pressure at the other end. As a result, an exhaust system is configured.

The exhaust system is configured to discharge a gas separated from the mixed gas in the separation device 21 (gas mainly containing air) to the outside of the purge device 20 through the exhaust pipes 81 and 82.

A first valve 24 is provided in the exhaust pipe 81. The first valve 24 is capable of blocking the flow of the gas that flows through the exhaust pipe 81.

A second valve 26 is provided in the exhaust pipe 82. The second valve 26 is capable of blocking the flow of the gas that flows through the exhaust pipe 82.

The separation device 21 is a device that separates air from the mixed gas guided from the condenser 12 through the purge pipe 71. The separation device 21 has a container 22 and a separation module 23.

The container 22 has a box shape and has a space formed therein. The separation module 23 is accommodated in the space in the container 22.

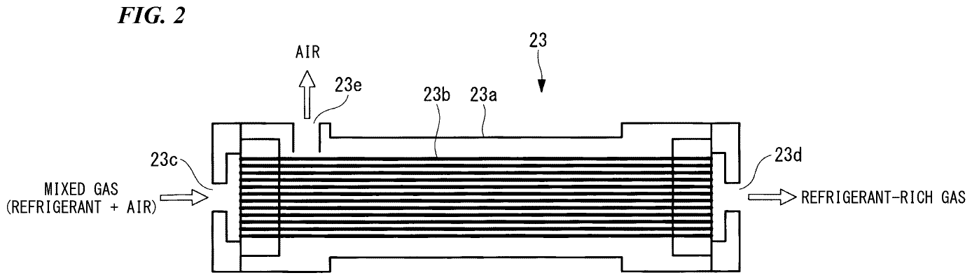

As shown in FIG. 2, the separation module 23 has a cylindrical housing 23a and a large number of separation membranes 23b.

The housing 23a has a purge inlet 23c, a purge outlet 23d, and an air outlet 23e. The purge inlet 23c communicates with the purge pipe 71. The purge outlet 23d communicates with the purge pipe 72. The air outlet 23e is formed inside the container 22 and communicates with the space.

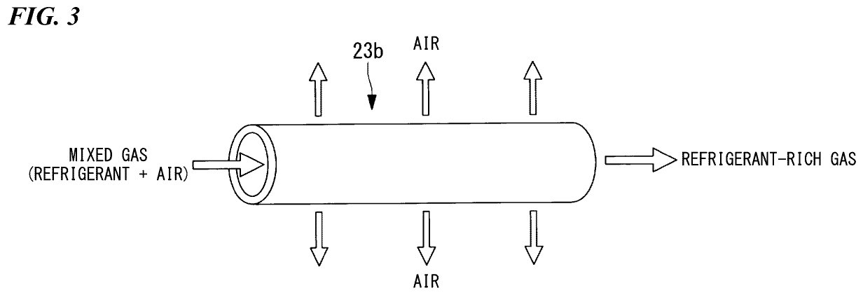

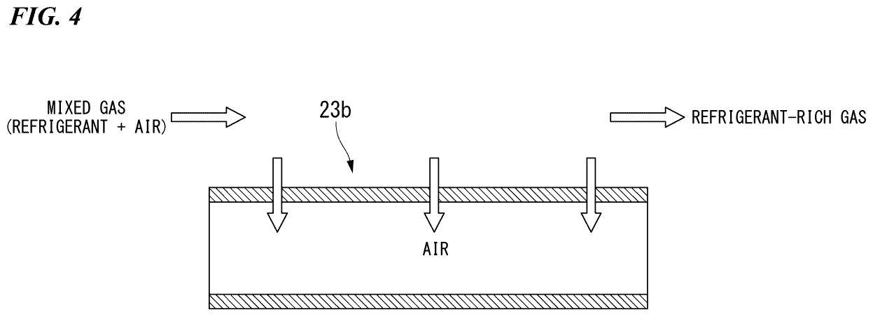

As shown in FIGS. 3 and 4, one separation membrane 23b is cylindrically formed. As shown in FIG. 2, a large number of the separation membranes 23b are accommodated in the housing 23a in a bundled state.

The mixed gas guided to the separation module 23 through the purge pipe 71 may be guided to, for example, the inside of the cylindrical separation membrane 23b as shown in FIG. 3. In this case, the pressure is made to be lower in the outside of the separation membrane 23b than in the inside, whereby mainly air in the mixed gas that flows inside permeates the separation membrane 23b outwards.

In addition, the mixed gas guided to the separation module 23 through the purge pipe 71 may flow, for example, outside the cylindrical separation membrane 23b as shown in FIG. 4. In this case, the pressure is made to be lower in the inside of the separation membrane 23b than in the outside, whereby mainly air in the mixed gas that flows outside permeates the separation membrane 23b inwards.

That is, the separation membrane 23b separates air from the mixed gas with a pressure difference generated between the upstream side and the downstream side.

The separation membrane 23b is a carbon membrane. The carbon membrane is an inorganic membrane in which a layer for separating air is formed of carbon or a carbide. The cylindrical separation membrane 23b in the present embodiment is a hollow fiber carbon membrane.

The separation membrane 23b does not prevent permeation of all of the refrigerant gas and has a characteristic of permeating a small amount of the refrigerant gas together with air. However, the permeation rate of the refrigerant gas is significantly slow compared with the permeation rate of air.

Specifically, the separation membrane 23b, which is a carbon membrane, has a large number of pores (not shown) for passing mainly air (an oxygen gas, a nitrogen gas, and the like). The pore diameter of the separation membrane 23b is 0.3 nm or more and 0.5 nm or less, and more preferably 0.35 nm or more and 0.45 nm or less.

Here, the molecular diameter of R1233zd, which is a kind of refrigerant, is about 0.5 nm. In addition, the molecular diameters of R123 and R133, which are different kinds of refrigerant, are 0.452 nm or more. In addition, the molecular diameter of R11, which is a different kind of refrigerant, is 0.419 nm or more.

On the other hand, the molecular diameters of a nitrogen gas mainly constituting the air is 0.368 nm on average. In addition, the molecular diameters of an oxygen gas mainly constituting the air is 0.343 nm on average.

Therefore, the molecular diameters of the nitrogen gas and the oxygen gas mainly constituting the air are small compared with the molecular diameters of the refrigerants, such as R1233zd, R123, R133, and R11. In addition, these nitrogen gas and oxygen gas pass through the pores of the separation membrane 23b more easily than the refrigerants, such as R1233zd, R123, R133, and R11.

In the separation device 21 configured as described above, the gas flows as follows.

The mixed gas guided to the separation device 21 through the purge pipe 71 is guided into the housing 23a from the purge inlet 23c. The mixed gas guided to the housing 23a flows in the upstream sides of the separation membranes 23b. At this time, in a case where the pressure on the downstream side of the separation membrane 23b is lower than the pressure on the upstream side of the separation membrane 23b, the air that is contained in the mixed gas flowing in the upstream side of the separation membrane 23b permeates toward the downstream side of the separation membrane 23b. The air separated from the mixed gas is discharged from the air outlet 23e to the space formed inside the container 22 and is guided to the exhaust pipe 81. On the other hand, the mixed gas from which the air has been separated and which flows in the upstream sides of the separation membranes 23b (that is, refrigerant-rich gas) is returned to the refrigerant pipe 91 or the compressor 11 through the purge pipe 72 from the purge outlet 23d.

In the above description, the “upstream side” of the separation membrane 23b corresponds to the inside of the cylindrical separation membrane 23b in FIG. 3, and corresponds to the outside of the cylindrical separation membrane 23b in FIG. 4. In addition, the “downstream side” of the separation membrane 23b corresponds to the outside of the cylindrical separation membrane 23b in FIG. 3, and corresponds to the inside of the cylindrical separation membrane 23b in FIG. 4.

### [Operation of Purge Device]

Next, an example of the operation of the purge device 20 of the present embodiment will be described.

In the purge device 20, the vacuum pump 27 is operated, and the first valve 24 and the second valve 26 are opened. At this time, a pressure difference is generated between the upstream side and the downstream side of the separation membrane 23b. Along with the pressure difference, mainly the air that is contained in the mixed gas permeates toward the downstream sides of the separation membranes 23b. The refrigerant that is contained in the mixed gas also permeates toward the downstream sides of the separation membranes 23b, but the permeation rate of the refrigerant gas that permeates the separation membranes 23b is considerably slow compared with the permeation rate of the air due to the characteristics (particularly, the pore diameters) of the separation membranes 23b. Therefore, the majority of the gas that permeates the separation membranes 23b is the air.

The air that has permeated the separation membranes 23b is discharged to the outside through the exhaust pipe 81, the vacuum pump 27, and the exhaust pipe 82. On the other hand, the refrigerant-rich gas from which the majority of the air has been separated is returned to the refrigerant pipe 91 or the compressor 11 from the upstream sides of the separation membranes 23b through the purge outlet 23d of the housing 23a and the purge pipe 72.

### [Production Method for Separation Membrane]

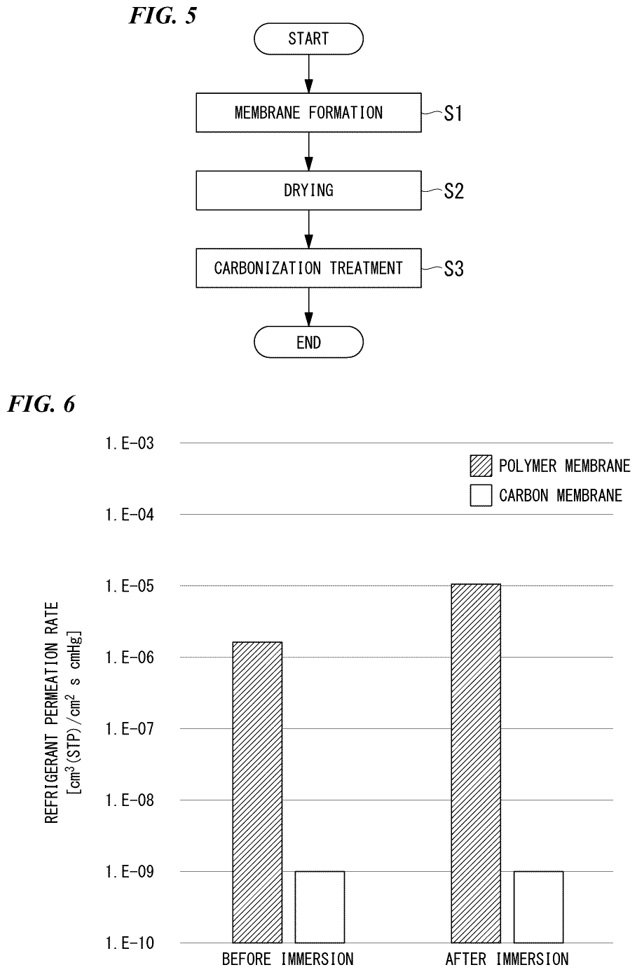

Next, a production method for the separation membrane 23b of the present embodiment will be described with reference to mainly FIG. 5. Hereinafter, an example of a production method for a hollow fiber carbon membrane will be described, but the following production method can also be applied to production methods for a carbon membrane having any shape.

In the production method for a hollow fiber carbon membrane, a polyphenylene oxide derivative that is substantially composed of repeating units represented by Formula (a) and Formula (b) below and in which a proportion A (%) of the repeating unit (b) to (a)+ (b) is 15%<A<60% is prepared as a polymer material.

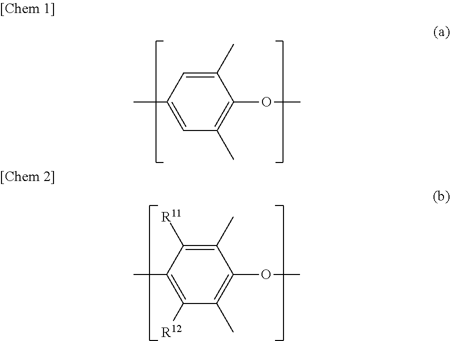

R¹¹ and R¹² in Formula (b) each independently represent a hydrogen atom, a —SO₃H group, or a —SO₃NH₄ group. Here, R¹¹ and R¹² are not both a hydrogen atom.

Next, the polyphenylene oxide derivative is dissolved in any solvent to prepare a membrane-forming stock solution (precursor polymer solution). In this case, a substance or the like that maintains the stability of the solution may be added in an amount within the range of the initial purpose. Examples of the solvent used here include methanol, ethanol, tetrahydrofuran, N,N-dimethylacetamide, and N-methyl-2-pyrrolidone, and these can be used as a mixture.

Thereafter, a membrane is formed from the membrane-forming stock solution, thereby obtaining a membrane-forming body as shown in FIG. 5 (a membrane forming step S1). In the membrane forming step S1, the membrane-forming stock solution is extruded from an outer tube of a hollow fiber spinning nozzle having a double tube annular structure into a coagulation bath, and a core liquid that is mixed with the solvent of the membrane-forming stock solution but is insoluble in the polyphenylene oxide derivative is simultaneously extruded from an inner tube of the spinning nozzle, thereby forming a hollow fiber-like product as a membrane-forming body.

The core liquid and the coagulation bath that are used in the membrane forming step S1 are solvents that are mixed with the solvent of the membrane-forming stock solution, but are insoluble in the above-described polyphenylene oxide derivative, as such solvents, water or an ammonium salt aqueous solution are preferably used, and as the ammonium salt, ammonium nitrate, ammonium chloride, and ammonium sulfate are exemplary examples. The temperatures of the core liquid and the coagulation bath are −20° C. to 60° C., and more preferably 0° C. to 30° C.

Thereafter, the hollow fiber-like product (membrane-forming body) obtained in the membrane forming step S1 is dried, thereby obtaining a precursor polymer membrane having various shapes (drying step S2).

The precursor polymer membrane obtained in the drying step S2 may be carbonized as it is in a carbonization treatment step S3, which will be described below, but may also be subjected to, for example, a heating treatment at about 150° C. to 300° C. for 30 minutes to 4 hours and a temperature lower than the carbonization temperature, thereby obtaining a precursor infusible treatment membrane that is the precursor polymer membrane on which an infusible treatment has been performed. The infusible treatment that is performed on the precursor polymer membrane particularly improves the performance as a hollow fiber carbon membrane.

Further, the precursor polymer membrane or the precursor infusible treatment membrane obtained through the above-described steps is subjected to a carbonization treatment at 450° C. to 850° C. (carbonization treatment step S3). In the carbonization treatment step S3, the precursor is subjected to a carbonization treatment at 450° C. to 850° C., thereby obtaining a hollow fiber carbon membrane having a pore diameter of 0.3 nm or more and 0.5 nm or less.

In the carbonization treatment step S3, for example, the precursor is accommodated in a container and subjected to a heating treatment with no decompression treatments under a reduced pressure of 10-4 atm or lower or under an inert gas atmosphere substituted with helium, an argon gas, a nitrogen gas, or the like, thereby producing a hollow fiber carbon membrane.

The heating conditions vary depending on the kind and amount of a material constituting the precursor, but the precursor is heated at 450° C. to 850° C. for 30 minutes to 4 hours under a reduced pressure of 10-4 atm or lower or under an inert gas atmosphere.

The production of the hollow fiber carbon membrane is completed by ending the above-described carbonization treatment step S3.

In the purge device 20 of the present embodiment, the separation membrane 23b is a carbon membrane. Therefore, even in a case where a liquid refrigerant comes into contact with the separation membrane, plasticization does not occur in the separation membrane. As a result, it is possible to suppress an increase in the permeation rate of the refrigerant in the separation membrane. Therefore, it is possible to suppress deterioration of the air (non-condensable gas) separation performance even in a case where a liquid refrigerant comes into contact with the separation membrane.

In addition, in the purge device 20 of the present embodiment, the pore diameter of the separation membrane 23b is 0.3 nm or more and 0.5 nm or less, and more preferably 0.35 nm or more and 0.45 nm or less. Therefore, as described above, the nitrogen gas and the oxygen gas that are contained in the air pass through the pores of the separation membrane 23b more easily than the refrigerants, such as R1233zd, R123, R133, and R11. Therefore, the separation membrane 23b is capable of exhibiting excellent separation performance.

In addition, in the production method for the separation membrane 23b according to the present embodiment, the precursor polymer membrane is subjected to the carbonization treatment at 450° C. or higher and 850° C. or lower, whereby a separation membrane can be obtained as a carbon membrane having a pore diameter of 0.3 nm or more and 0.5 nm or less.

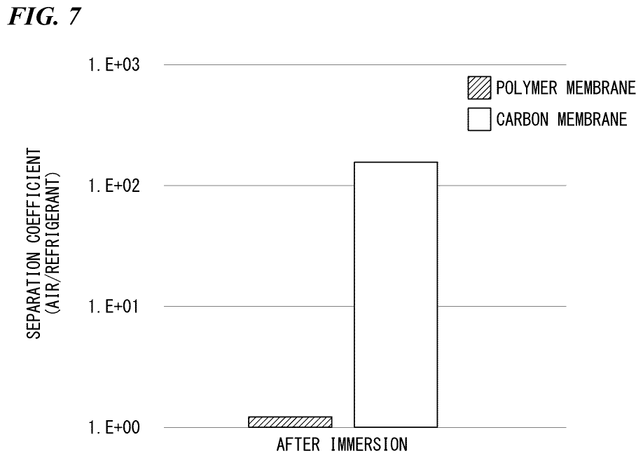

The effects of the separation membrane 23b according to the present embodiment will be further described with reference to FIG. 6 and FIG. 7.

FIG. 6 is a graph comparing the carbon membrane and the polymer membrane in terms of the permeation rate of the refrigerant in the separation membrane. The graph of FIG. 6 shows the measurement results of the permeation rates each of before the carbon membrane and the polymer membrane are immersed in the liquid refrigerant (before immersion) and after the immersion (after immersion). The liquid refrigerant used for immersing the separation membrane and the refrigerant gas used for measuring the permeation rates are both R1233zd. In addition, the polymer membrane is a polyimide membrane. In the graph of FIG. 6, it is shown that the permeation rates of the refrigerant gas in the separation membrane is lower in the carbon membrane than in the polymer membrane, regardless of before and after the immersion of the separation membrane in the liquid refrigerant. That is, it is found that the carbon membrane is less likely to allow the refrigerant gas to permeate than the polymer membrane.

In addition, according to the graph of FIG. 6, in the polymer membrane, in a case where the polymer membrane is immersed in the liquid refrigerant, the permeation rate of the refrigerant gas in the polymer membrane increases. That is, it was possible to confirm that in a case where the polymer membrane comes into contact with the liquid refrigerant, plasticization occurs in the polymer membrane, and the function of suppressing the permeation of the refrigerant gas deteriorates.

On the other hand, it is found that in the carbon membrane, the permeation rate of the refrigerant gas does not increase even in a case where the carbon membrane is immersed in the liquid refrigerant. That is, it was possible to confirm that even in a case where the carbon membrane comes into contact with the liquid refrigerant, plasticization does not occur in the carbon membrane, and the function of suppressing the permeation of the refrigerant gas is maintained.

FIG. 7 is a graph comparing the carbon membrane and the polymer membrane in terms of the air separation performance in the separation membrane after being immersed in the liquid refrigerant. In the graph of FIG. 7, the air separation performance is indicated by “separation coefficient”. The separation coefficient is a value obtained by dividing the permeation rate of the air by the permeation rate of the refrigerant gas. The higher the numerical value of the separation coefficient, the higher the air separation performance. In FIG. 7, the refrigerant used for immersing the separation membrane and the refrigerant used for measuring the permeation rates are both R1233zd. In addition, the polymer membrane is a polyimide membrane.

According to the graph of FIG. 7, the separation coefficient of the polymer membrane after immersion in the liquid refrigerant is 1.2. That is, in the polymer membrane, the permeation rate of the air and the permeation rate of the refrigerant gas are almost equal to each other. From this fact, it was possible to confirm that in a case where the polymer membrane comes into contact with the liquid refrigerant, plasticization occurs in the polymer membrane, and the air separation performance extremely deteriorates.

On the other hand, the separation coefficient of the carbon membrane after immersion in the liquid refrigerant is 100 or more. That is, in the carbon membrane, the permeation rate of the air is extremely high as compared with the permeation rate of the refrigerant gas. From this fact, it was possible to confirm that even in a case where the carbon membrane comes into contact with the liquid refrigerant, plasticization does not occur in the carbon membrane, and a state where the air separation performance is extremely high is maintained.

Hitherto, the embodiment of the present disclosure has been described in detail with reference to the drawings, but the specific configuration is not limited to this embodiment and includes design changes and the like within a range that does not deviate from the gist of the present disclosure.

In the present disclosure, the cylindrical separation membrane as the carbon membrane may be, for example, a tubular membrane in which a plurality of hollow fiber carbon membranes are arranged in an annular shape. In addition, the separation membrane as the carbon membrane may be, for example, a flat membrane.

### <Appendix>

The purge device 20 and the production method for the separation membrane 23b described in the above-described embodiment are understood as follows, for example.
(1) A purge device 20 according to a first aspect is a purge device 20 including purge pipes 71 and 72 that are connected to a condenser 12 and purges a mixed gas containing a refrigerant gas and a non-condensable gas from the condenser 12, separation membranes 23b that are provided in the purge pipes 71 and 72 and separate the non-condensable gas from the mixed gas purged by the purge pipes 71 and 72 with a pressure difference; and exhaust pipes 81 and 82 that guide a gas containing the non-condensable gas separated by the separation membranes 23b to an outside, and the separation membrane 23b is a carbon membrane.

In the above-described configuration, the separation membrane 23b is a carbon membrane, whereby plasticization does not occur in the separation membrane 23b even in a case where a liquid refrigerant comes into contact with the separation membrane 23b. Therefore, it is possible to suppress an increase in the permeation rate of the refrigerant in the separation membrane 23b. Therefore, it is possible to suppress deterioration of the non-condensable gas separation performance even in a case where the liquid refrigerant comes into contact with the separation membrane 23b.
(2) A purge device 20 according to a second aspect is the purge device 20 according to (1), in which a pore diameter in the separation membrane 23b is 0.3 nm or more and 0.5 nm or less.
(3) A purge device 20 according to a third aspect is the purge device 20 according to (1), in which a pore diameter in the separation membrane 23b is 0.35 nm or more and 0.45 nm or less.

In these configurations, in a case where the non-condensable gas is mainly air containing a nitrogen gas and an oxygen gas, the separation membrane 23b is capable of exhibiting excellent separation performance.
(4) A purge device 20 according to a fourth aspect is the purge device 20 according to any one of (1) to (3), in which the non-condensable gas contains at least a nitrogen gas or an oxygen gas, and a molecular diameter of the refrigerant gas is 0.4 nm or more.

The molecular diameter of the nitrogen gas is 0.368 nm on average, and the molecular diameter of the oxygen gas is 0.343 nm on average. Therefore, the molecular diameters of the nitrogen gas and the oxygen gas are small compared with the molecular diameters (0.4 nm or more) of the refrigerant gases, such as R1233zd, R123, R133, and R11. As a result, the nitrogen gas and the oxygen gas pass through the pores of the separation membrane 23b more easily than the refrigerant gas. Therefore, the nitrogen gas and the oxygen gas can be efficiently separated from the mixed gas in the separation membrane 23b.
(5) A production method for the separation membrane 23b according to a fifth aspect is a production method for the separation membrane 23b for producing the separation membrane 23b that separates a non-condensable gas from a mixed gas containing a refrigerant gas and the non-condensable gas, the method having a step of obtaining a membrane-forming body by forming a membrane of a membrane-forming stock solution containing a polymer material, a step of obtaining a precursor polymer membrane by drying the membrane-forming body, and a step of obtaining the separation membrane 23b as a carbon membrane having a pore diameter of 0.3 nm or more and 0.5 nm or less by subjecting the precursor polymer membrane to a carbonization treatment at 450° C. to 850° C.

In the production method, the precursor polymer membrane is subjected to the carbonization treatment at 450° C. or higher and 850° C. or lower, whereby the separation membrane 23b can be obtained as a carbon membrane having a pore diameter of 0.3 nm or more and 0.5 nm or less.

### REFERENCE SIGNS LIST

10 Refrigerator
11 Compressor
12 Condenser
13 Expansion valve
14 Evaporator
20 purge device
21 Separation device
22 Container
23 Separation module
23a Housing
23b Separation membrane
27 Vacuum pump
81, 82 Exhaust pipe

1. A purge device comprising:
a purge pipe that is connected to a condenser and purges a mixed gas containing a refrigerant gas and a non-condensable gas from the condenser;
a separation device having a separation membrane that is provided in the purge pipe and separates the non-condensable gas from the mixed gas purged by the purge pipe with a pressure difference; and
an exhaust pipe that guides a gas containing the non-condensable gas separated by the separation membrane to an outside,
wherein the separation membrane is a carbon membrane.

2. The purge device according to claim 1, wherein a pore diameter in the separation membrane is 0.3 nm or more and 0.5 nm or less.

3. The purge device according to claim 1, wherein a pore diameter in the separation membrane is 0.35 nm or more and 0.45 nm or less.

4. The purge device according to claim 1, wherein
the non-condensable gas contains at least a nitrogen gas or an oxygen gas, and
a molecular diameter of the refrigerant gas is 0.4 nm or more.

5. A production method for a separation membrane for producing a separation membrane that separates a non-condensable gas from a mixed gas containing a refrigerant gas and the non-condensable gas, the method comprising:
a step of obtaining a polymer structure in a shape of a membrane that is produced from a solution containing a polymer raw material;
a step of obtaining a precursor polymer membrane by drying the polymer structure; and
a step of obtaining the separation membrane as a carbon membrane having a pore diameter of 0.3 nm or more and 0.5 nm or less by subjecting the precursor polymer membrane to a carbonization treatment at 450° C. to 850° C.

6. The purge device according to claim 1, further comprising:
a first exhaust pipe;
a second exhaust pipe; and
a vacuum pump, wherein
the first exhaust pipe is connected to the separation device at one end and is connected to the vacuum pump at the other end,
the second exhaust pipe is connected to the vacuum pump at one end and is opened to the atmospheric pressure at the other end, and
when the the vacuum pump is operated, a pressure difference is generated between the upstream side and the downstream side of the separation membrane.

7. The purge device according to claim 1, wherein
the purge pipe includes:
a first purge pipe connected to the condenser at one end and connected to the separation device at the other end; and
a second purge pipe connected to the separation device at one end and connected to a refrigerant pipe or the compressor at the other end, wherein the refrigerant pipe connects a refrigerant outlet of the compressor and a refrigerant inlet of an outlet of the condenser,
the mixed gas purged from the condenser is guided to the separation device through the first purge pipe, and
after the mixed gas is separated in the separation device, then return the mixed gas to the refrigerant pipe or the compressor existing upstream of the condenser through the second purge pipe.
